(19) United States
(12) Patent Application Publication
(10) Pub. No.: US 2022/0416963 A1
(43) Pub. Date: Dec. 29, 2022

(54) METHODS AND DEVICES FOR HANDLING PRIVATE TRANSMISSIONS FROM A WIRELESS DEVICE

(71) Applicant: Sony Group Corporation, Tokyo (JP)

(72) Inventors: Olof ZANDER, Södra Sandby (SE); Kun ZHAO, Malmö (SE); Erik BENGTSSON, Eslöv (SE); Fredrik RUSEK, Eslöv (SE); Jose FLORDELIS, Lund (SE)

(21) Appl. No.: 17/781,466

(22) PCT Filed: Dec. 15, 2020
(86) PCT No.: PCT/EP2020/086152

§ 371 Date: Jun. 1, 2022

(30) Foreign Application Priority Data
Dec. 20, 2019 (SE) 1951521-2

(51) Int. Cl. H04L 5/00

(52) U.S. Cl. CPC H04L 5/0044; H04L 5/0091; H04W 92/18

(57) ABSTRACT

A method is disclosed performed by a Wireless Device (WD) for handling one or more private transmissions (PT) from the WD in a wireless communication network. The method comprises receiving synchronization signaling occupying one or more first resource elements of a synchronization signal burst transmitted by a radio network node. The method comprises communicating PT in one or more second resource elements located on same time resources as the synchronization signal burst, wherein the one or more second resource elements are different from the one or more first resource elements.

The present disclosure relates to a wireless device, a radio network node and methods performed therein for handling private transmissions from the wireless device in a wireless communication network.

### BACKGROUND

In 3^{rd} Generation Partnership Project (3GPP) New Radio (NR) resource elements are periodically allocated to a Synchronization Signals and Physical Broadcast Channel (SS/PBCH) block, which is commonly referred to as Synchronization Signal Blocks (SSBs). The SSBs are repetitively broadcasted from a radio base station, such as a NR NodeB (gNB), with the purpose of allowing the gNB and a Wireless Device (WD) to select high quality beams to be used in the communication. During the time symbols in which the SSB is sent, the SSB occupies only a portion of the available subcarriers (SCs). An SSB block comprises a Primary Synchronization Signal (PSS), a Secondary Synchronization Signal (SSS) and a Physical Broadcast Channel (PBCH). By detecting the synchronization signals, the WD can obtain a physical cell identity, achieve downlink synchronization in both time and frequency domain, and acquire a timing for PBCH. The PBCH carries basic system information. The frequency bandwidth (BW) of the SSB spans 240 contiguous SCs and 4 time-symbols (OFDM symbols) for each beam. The first symbol of the SSB comprises only PSS spanning only a subset (127 contiguous SCs) of the 240 SCs of the beam. Similarly, the third symbol of the SSB, which carries the SSS and some PBCH also spans only a subset of the 240 SCs of the beam. The resources not occupied by the SSB are not used for any other transmission and are thus empty. In a time-domain, the first symbol is the PSS, the second symbol is PBCH, the third symbol is SSS and the fourth symbol is PBCH. A first symbol index of a candidate SSB is determined according to subcarrier spacing of the SSB, where an index 0 corresponds to the first symbol of the first slot in a half-frame of a subframe. To enable beam sweeping of SS and PBCH, the transmission of SSBs may be organized in a periodical series of SS burst set. To minimize always-on transmissions, multiple SSBs are transmitted in a localized burst set in conjunction with a sparse burst set periodicity (default at 20 ms). Within an SS burst set period, up to 64 SSBs can be transmitted in different beams. The transmission of SSBs within the SS burst set is confined to a 5 ms window (half radio frame). Within this 5 ms window, the number of possible candidate SS block location is L. Based on the subcarrier spacing, the number of slots and/or symbols for SS can vary within this 5 ms time window. The set of SS Blocks transmitted define the SSB burst. Start symbol index defines the slot where the first symbol of each SSB will be transmitted, and the SSB will span three following symbols. The set of possible SSB time locations within an SS burst set depends on the numerology which in most cases is uniquely identified by the frequency band. The frequency location of SSB is not necessarily in the center of the system bandwidth and is configured by higher layer parameters to support sparser search raster for SSB detection. A sparser raster in frequency is required to compensate for the increased search time due to the sparser SSB periodicity.

Furthermore, in 3GPP WDs do not have to communicate via a radio network node but can also use Private Transmissions (PT), such as e.g. Device-to-Device (D2D) communication, or other transmissions, such as radar transmissions, which do not involve the radio network node. D2D communication technology refers to a radio technology that enables wireless terminals to communicate directly with each other without routing the data through a network infrastructure, such as to a radio network node. D2D communication may e.g. be used for proximity-based services where devices detect their proximity and subsequently trigger different services, such as advertisements, local exchange of information, smart communication between vehicles, etc. Other applications may comprise public safety support, where devices may provide local connectivity in case of out-of-coverage or damage to the network infrastructure. D2D communication provides advantages such as enhanced coverage of the wireless communication network, improved spectrum efficiency (such as a more efficient use of available resources), reduced communication delay (also referred to as latency), as well as reduced energy consumption; however, it still has some shortcomings, such as security issues, mobility management, and handoff. Furthermore, D2D communication provides new challenges for interference management, security, mobility management and other aspects.

### SUMMARY

In order to ensure that WDs can successfully receive SSBs for setting up a channel to the network node there are typically no signals transmitted in resource elements surrounding the PSS, SSS and PBCH of each SSB. Additionally, there are typically no data located at SCs outside the SSB block, such as in other frequency resources of the time resources used for transmission of the SSBs. These downlink resources are thus not used and can thus be considered wasted. With the rapid growth of mobile devices and services, available resources for transmitting signaling, such as transmissions to the radio network node (such as uplink transmissions) and/or PTs, is becoming more and more scarce. However, using these wasted downlink resources for other transmissions may cause interference to WDs listening for synchronization signaling.

Accordingly, there is a need for devices (wireless device and radio network node) and methods for handling private transmissions from the WD in a wireless communication network, which mitigate, alleviate or address the shortcomings existing and provide a more efficient usage of available resources and an increased spectrum efficiency of the radio wireless communications network.

A method is disclosed, performed by a first Wireless Device (WD), for handling one or more private transmissions (PTs) from a WD in a wireless communication network. The method comprises receiving synchronization signaling occupying one or more first resource elements of a synchronization signal burst transmitted by a radio network node. The method further comprises communicating PT in one or more second resource elements located on same time resources as the synchronization signal burst, wherein the one or more second resource elements are different from the one or more first resource elements.

Further, a WD is provided, the device comprising a memory circuitry, a processor circuitry, and a wireless interface, wherein the wireless device is configured to perform the method as disclosed herein.

Further, a method is disclosed, performed by a radio network node, for enabling PT from a wireless device (WD), such as PT between a first WD and a second WD, in a wireless communication network. The method comprises transmitting, to the WD, synchronization signaling occupying one or more first resource elements of a synchronization signal burst. The method further comprises signaling, to the WD, information indicating that the WD may transmit PT in one or more second resource elements located on same time resources as the synchronization signal burst, wherein the second resource elements are different from the one or more first resource elements.

Further, a radio network node is provided, the radio network node comprising a memory circuitry, a processor circuitry, and a wireless interface, wherein the wireless device is configured to perform the method as disclosed herein.

It is an advantage of the present disclosure that the WD may perform PT on resources associated with downlink synchronization signaling, such as downlink resources transmitted in or around SSBs, that were previously wasted, without causing interference and desensitization of neighboring WDs. Using the resources associated with downlink synchronization signaling for PT may also increase the resources available for communications other than PT in resource spectrums dedicated to these other communications.

Further, by the radio network node signaling to the WD that the WD may use resource elements located on same time resources as the synchronization signal burst other than the resource elements of the synchronization signaling used by the WD and/or resource elements of synchronization signaling related to neighboring beams, appropriate resources for PT may be signaled to the WDs with minimal overhead.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1 is a diagram illustrating an exemplary wireless communication system comprising an exemplary network node and exemplary wireless devices according to this disclosure,

FIG. 2 is a diagram illustrating available resources of a synchronization signal block,

FIG. 3 is a diagram illustrating available resources surrounding a synchronization signal block in a subframe,

FIG. 4 illustrates two exemplary methods to reduce interference caused by private transmissions from a wireless device,

FIG. 5 is a signaling diagram illustrating an exemplary method for handling private transmissions according to one or more embodiments according to this disclosure,

FIG. 6 is a flow-chart illustrating an exemplary method, performed in a wireless device, for handling private transmissions from the wireless device in the wireless communication network according to this disclosure,

FIG. 7 is a flow-chart illustrating an exemplary method, performed in a radio network node of a wireless communication system, for enabling private transmissions from the wireless device according to this disclosure,

FIG. 8 is a block diagram illustrating an exemplary wireless device according to this disclosure, and

FIG. 9 is a block diagram illustrating an exemplary radio network node according to this disclosure, and

FIG. 10 is a signaling diagram illustrating an exemplary procedure for handling private transmissions from the wireless device.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The figures are schematic and simplified for clarity, and they merely show details which aid understanding the disclosure, while other details have been left out. Throughout, the same reference numerals are used for identical or corresponding parts.

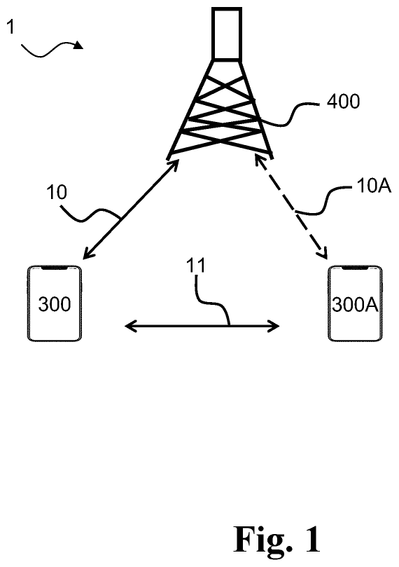

FIG. 1 is a diagram illustrating an exemplary wireless communication system 1 comprising an exemplary network node, such as a radio network node 400 and an exemplary WD 300 according to this disclosure.

As discussed in detail herein, the present disclosure relates to a wireless communication system 1 comprising a cellular system, e.g. a 3GPP wireless communication system. The wireless communication system 1 comprises a first wireless device 300 and/or a radio network node 400.

A radio network node disclosed herein refers to a radio access network node operating in the radio access network, such as a base station, an evolved Node B (eNB), or a gNB.

The wireless communication system 1 described herein may comprise one or more WDs 300, 300A, such as the first WD 300 and a second WD 300A, and/or one or more network nodes 400, such as one or more of: a base station, an eNB, a gNB and/or an access point.

A WD may refer to a mobile device and/or a user equipment (UE).

The wireless device 300, 300A may be configured to communicate with the radio network node 400 via a wireless link (or radio access link) 10, 10A. The wireless device 300, 300A may further be configured to communicate using a PT. The wireless device communicating using PT may comprise communicating with another wireless device 300A, 300 using a wireless link, such as a side-link 11, e.g. for device-to-device communications, or using other types of transmission (e.g. radar transmission). Hence, a private transmission is a transmission in the wireless communication system 1 which is not transmitted via the radio network node, but between one or more wireless devices 300, 300A, such as between the first WD 300 and the second WD 300A.

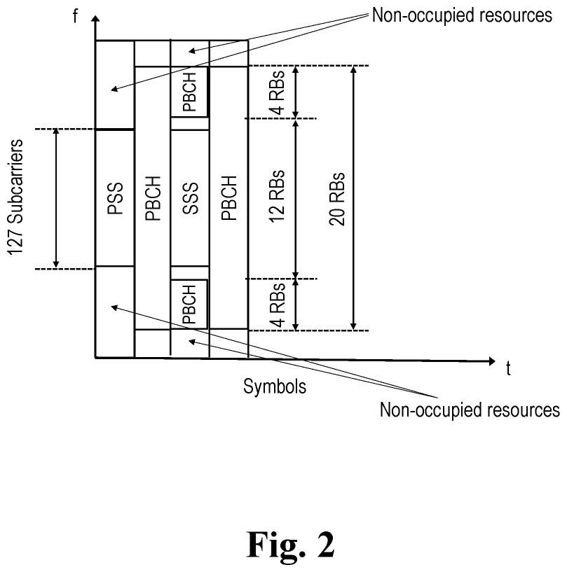

The present disclosure proposes to use resources in or around a set of resource elements associated to synchronization signals (e.g. an SSB resource set) for PT (e.g. Device-to-Device (D2D), radar scanning, Radio-Frequency Identification (RF ID) tags etc.). In a Time Division Duplex (TDD) system, empty resources during the transmission of synchronization signals, such as SSB transmission, may be made available for all WDs served by a network node, since the synchronization signal is a broadcasted signal. Therefore, the PT of a WD in the network, such as in a cell of a radio network node, may fully use these empty resources. Thus, no dedicated resources are needed for the PT. An illustration of free resources around the SSB symbols is shown in FIG. 2. The non-occupied resources around the SSB symbols are resource elements located in same time resources as the SSB symbols but on different frequency resources from the SSB symbols. The non-occupied resources, which may also be referred to as empty resources, in the SSB symbols are resource elements within the set of resource elements allocated for the SSB, which are not used for transmitting the PSS, SSS or PBCH. Occupied resources (such as resources allocated for PSS, SSS and PBCH) of other SSBs than at least the active SSB (and/or one or more SSBs adjacent to the active SSB) of a wireless device, such as SSBs having a receive power below a power threshold, may in some exemplary methods also be used for PT from the wireless device. These occupied resources are usually associated with distant wireless devices which are less sensitive to interference and thus the time and frequency resources of these SSBs may be used for PT from the wireless device.

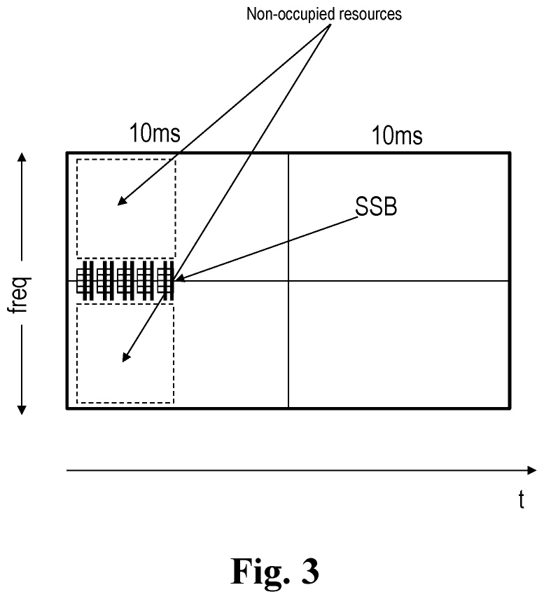

FIG. 3 shows a wide frequency BW where the SSB occupies approximately 25% of the symbols of the sub-frame and a small part of the available BW. The areas of the SSB marked with horizontal stripes illustrates PSS and SSS with additional un-used resources compared to the black bars, which is the PBCH. Not shown in the figure is the payload data, typically allocated on symbols not overlapping with the SSB (such as in the 15 ms following the SSBs of each subframe). Hence, a large amount of the resources is wasted in each subframe. The SSBs are DL signals, and to use the same time symbols, although different SCs, for other transmissions may cause interference and a desensitization for neighboring WDs trying to synchronize themselves to the radio network node. Desensitization is a reduction in sensitivity caused by interference. Such desensitization may be harmful since signal levels may be low during the synchronization stage, e.g. due to the fact that a typical WD operating in higher frequency ranges (such as in Frequency Range 2 (FR2), which comprises frequency bands from 24.25 GHz to 52.6 GHz) has not yet established its spatial filter (i.e. beam) during synchronization.

In order to monitor beam changes due to mobility, the SSBs are also needed for WDs that have synchronized to the wireless communications network and are in connected mode. The methods provided herein thus provide a solution for increasing signaling capacity in the wireless communications network while avoiding or at least reducing the interference and desensitization of other WDs, wherein the other WDs may be WDs not communicating via PT.

Furthermore, since the synchronization signal is a cell specific signal with periodic transmission, the WD may determine which resources that could be used for the PT based on the knowledge of the periodicity without requiring further signaling requesting a resource allocation for PT. As an example, if a group of WDs are located within the same beam-coverage of a radio network node, the WDs in the group may all listen to the same synchronization signaling, such as the same SSB, for beam management. The synchronization signaling which the group of WDs listen to is typically the synchronization signaling related to the strongest beam in that area. Since all of the WDs in the area may listen to the same synchronization signaling it would be fatal if one of the WDs started PT on resource elements of that synchronization signaling. On other blocks of synchronization signaling (such as SSBs) however, this is less of a problem as WDs potentially listening to these blocks of synchronization signaling are more distant from the WD intending to perform PT.

In one or more exemplary embodiments the WD, such as the first WD, may use any resources for PT as long as it avoids symbols in which the WD senses a strong synchronization signaling, i.e. a synchronization signaling with a receive power above a power threshold. This is due to such symbols being intended for beam management of other UEs potentially in the neighborhood of the WD intending to perform PT. This also means that resources outside the block of synchronization signals used by the WD (which may also be referred to as the active synchronization signals), such as resource elements located in the same time resources as the active synchronization signals may be used by the WDs for PT. During beam sweeping the WD can be assumed to be omni directional, (receive from various directions) and are thus more sensitive, while, during communication the WD uses a directive beam toward the gNB.

The radio network node, such as the gNB, may transmit a grant to the WD to transmit PT in empty resources allocated to synchronization signaling, such as to empty resources of an SSB. The radio network node may transmit the grant of PT either by broadcasting or explicitly signaling. The grant may be associated with a set of restrictions, such as one or more resource criterion and/or one or more transmission requirements, for the PT. The resource criterion may indicate which resources the WD is to use or not use for PT. The transmission requirements may indicate how the WD is to transmit in the resources indicated by the resource criterion. The set of restrictions are placed to reduce interference of neighboring WDs in order to avoid a desensitization of the neighboring WDs. The restrictions, such as the one or more resource criterion and/or the one or more transmission requirements, which may also be referred to as cell rules, may comprise one or more of the following:
a) A power level to be used for PT,
b) a spatial direction to be used for PT,
c) a beam width to be used for PT,
d) specific synchronization signaling (such as SSBs) or specific resources in synchronization signaling (such as SSB) to be avoided (based on the location of the synchronization signaling (such as SSB location) in the synchronization signaling burst set (such as SSB-burst set) derived from the PBCH),
e) whether PT is on/off (in case PT is not sanctioned),
f) various levels of PT (such as use SSB symbols, use any resources, use SSB symbols and UL symbols, use UL symbols),
g) a power threshold for a detected power level of different synchronization signaling (such as SSBs) in the synchronization signaling burst (such as SSB burst), wherein the power level threshold indicates synchronization signaling (such as SSBs) which may or may not be used for PT.

The resource criterion may comprise one or more of the specific SSBs or specific resources in SSB to be avoided (d), whether PT is on/off (e), and/or the various levels of PT (f) mentioned above. The transmission requirements may comprise one or more of the power level used for PT (a), the spatial direction of PT (b) and/or the beam width to be used with PT (c) mentioned above.

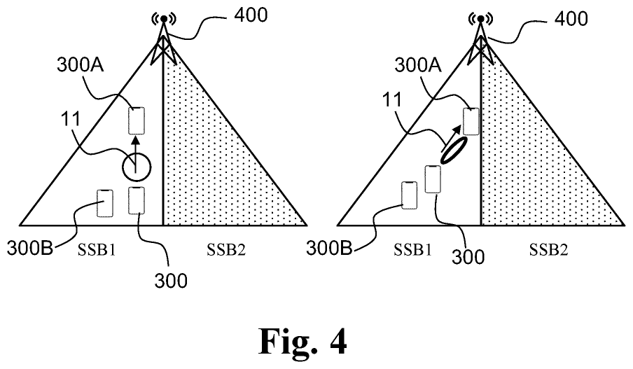

FIG. 4 illustrates two of a plurality of exemplary methods to reduce interference and desensitization of neighboring WDs caused by PT according to this disclosure. In these exemplary methods, a spatial filter or avoidance of specific SSBs may be used to avoid desensitization. Two WDs, such as a first WD 300 and a second WD 300A, are communicating using PT. In this case the PT is a side link between the WDs 300, 300A and a further WD 300B is out of the side link. All three WDs 300, 300A, 300B are using the same SSB of the radio network node 400. In the left figure of FIG. 4, the radio network node 400 may have signaled to the WDs 300, 300A, 300B that specific SSBs or specific resources in SSB is to be avoided, such as the active SSB1 of the WD or resources comprising PSS, SSS and/or PBCH of other SSBs than the active SSB1 (unoccupied resources in the other SSBs may be used for PT). The WD, such as the first WD 300, may also have received signaling from the radio network node 400 that SSB resources of the WD 300A, such as the second WD, which the WD 300 communicates with over the side-link should be avoided. Based on this signaling the WD 300 transmits the side link using empty resources of a different SSB symbol (circle) associated to a different beam of the radio network node than the beam associated with SSB1, to avoid interfering the neighboring WD 300B with the side link communication. In the right figure of FIG. 4, the radio network node 400 may have signaled a restriction in spatial direction to be used by the WDs 300, 300A, 300B. The restriction in spatial direction may indicate that PTs shall not be transmitted in the direction of the radio network node 400 or in the direction of the WD 300B. The restriction in spatial direction may however also indicate that the first WD 300 is to transmit side link only in the direction of the second WD 300A. The WD 300 may thus use a spatial filter to transmit only in a certain direction for side link, based on the restriction signaled by the radio network node, to avoid interfering the neighboring WD 300B.

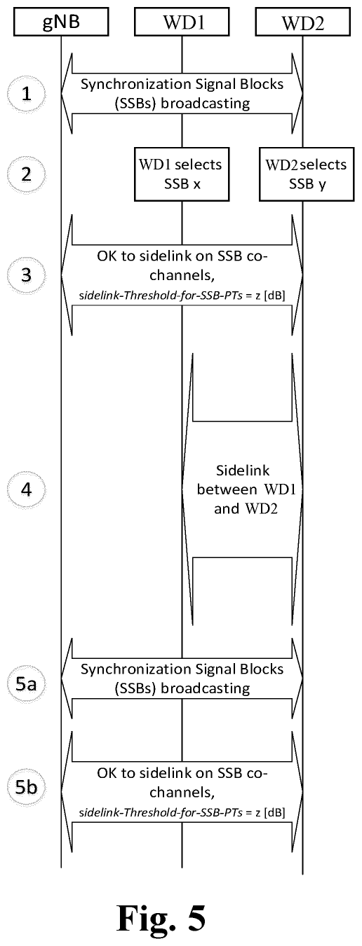

FIG. 5 illustrates an exemplary method for handling PT according to one or more embodiments herein. In step 1, an initial beam establishment is performed. The radio network node (gNB) periodically broadcasts synchronization signal sequences (such as SSBs) in a number of directions using a set of transmit beams. Two WDs, such as the first WD 300 and the second WD 300A of FIG. 1, in FIG. 5 referred to as WD1 and WD2, measure the received signal strength of the broadcasted SSBs and select the respective strongest SSB for communication with the gNB, together with a suitable receive spatial filter (receive beam). In this example, WD1 selects a first SSB (SSBx) and WD2 selects a second SSB (SSBy), in step 2. The gNB informs the WDs, such as WD1 and WD2, via broadcasting or explicit signaling, that PTs are permitted on empty SSB resources, subject to one or more restrictions. In this example, one of the one or more restrictions may be that the WDs are not allowed to transmit PTs in the direction of the selected SSB, or in the directions of SSBs with received signal strengths within a certain dB of the selected SSB, as illustrated in step 3. The dB value may be indicated as a power threshold (such as sidelink-Threshold-for-SSB-PTs). In step 4, the WD1 and the WD2 decide to engage in PT in accordance with the restrictions received from the gNB. (In some examples, the details (for example, the detailed implementation) of the setup, maintenance and termination of PTs are, however, not specified but illustrated in one or more embodiments of this disclosure or of this invention.) The WD1 and WD2 continuously listen to broadcasted SSBs and repeat the beam selection procedure, as shown in step 5a. The WDs, such as WD1 and WD2, may also keep track of potential changes of the PT policy (such as a change of restrictions for PT) as broadcasted by the gNB, as disclosed in step 5b, and may continuously adapt the selected resources for PT based on the selected beams and the current PT policy.

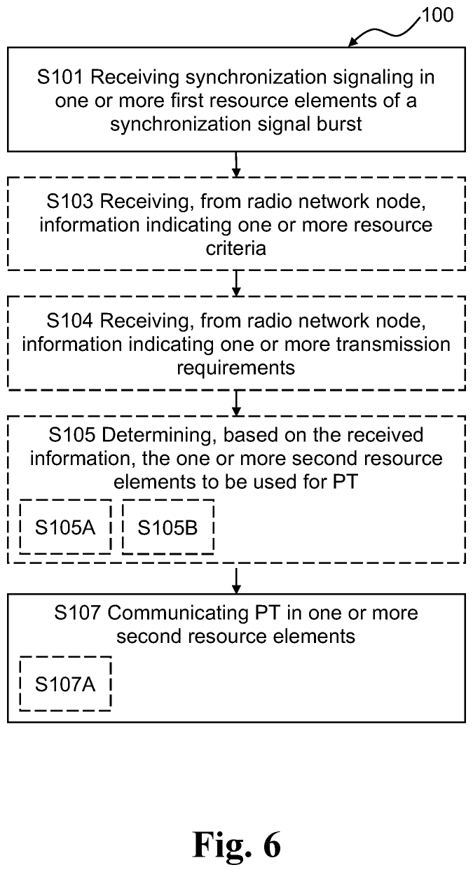

FIG. 6 shows a flow diagram of an exemplary method 100, performed by a WD (such as a WD disclosed herein, such as the first WD 300 of FIG. 1), for handling PT from the WD in a wireless communication network, according to the disclosure. The method 100 comprises receiving S101 synchronization signaling, occupying one or more first resource elements (such as a first SSB) of a synchronization signal burst (such as SSB burst) transmitted by a radio network node, such as a gNB. To enable beam sweeping of synchronization signals, the transmission of synchronization signals may be organized in a periodical series of synchronization signal burst sets. Within a synchronization signal burst, up to 64 synchronization signals associated to different beams may be transmitted. The transmission of synchronization signals within the synchronization signal burst may be confined to a 5 ms window (half radio frame). The synchronization signal occupying the one or more first resource elements of the synchronization signal burst relates to a first beam transmitted by the radio network node. This is for example the beam which is received with the highest receive power by the WD during a beam sweep performed by the radio network node. The synchronization signals may be received as a broadcasted message from the radio network node. The one or more resource elements may be one or more resources in a time domain and in a frequency domain.

The method 100 may further comprise receiving S103, from the radio network node, information indicating one or more resource criterion for determining one or more second resource elements (such as a second SSB) which is to be used for transmitting PT. The information indicating the resource criterion may comprise an indication of resource elements that are allowed and/or resource elements prohibited (in other words, resource elements that should be avoided) to be used for communicating PT. The information indicating the resource criterion may comprise an indication that specific SSBs or specific resources in SSB is to be avoided by the WD (such as the first WD), such as the active SSB of the WD (such as the first WD) and/or an active SSB resource of a counterpart WD (such as the second WD) participating in a side-link communication. In some exemplary methods herein, resources comprising PSS, SSS and/or PBCH of other SSBs than the active SSB may also be indicated as to be avoided (unoccupied resources in the other SSBs may be allowed to use for PT). The information may e.g. indicate that the WD is to use SSB symbols, use any resources, use SSB symbols and UL symbols, or use UL symbols for PT. The radio network node may signal to the WD that the WD is granted access to the empty resources of SSBs. The selection of the actual resources of the SSBs may then be performed by the WD. The radio network node may directly or indirectly signal the appropriate resources to be used for PT to the WD. The direct or indirect signaling of the appropriate resources may be done via the resource criterion. The resource criterion may indicate to not use the resource elements of SSBs visible to the WD, such as e.g. neighboring beams, as this may increase the risk for desensitization of neighboring WDs. The radio network node may signal to the WDs that, for each WD, PTs are not allowed on the resources of the signaling (such as the SSB) that the WD “listens to” (such as, the SSB the uses, or would use, to select a DL receive filter for communications with the radio network node). Thereby a minimum overhead is required for signaling the resources to use. The synchronization signaling (such as the SSB) that the WD listens to, such as the SSB of the beam of the radio network node that the WD selects or the SSB having the strongest receive power at the WD, may herein also be referred to as the active synchronization signaling (or active SSB).

The information indicating the resource criterion may comprise an indication that the first WD is prohibited to communicate PT on resource elements associated to a synchronization signal received with a power higher than a power threshold. The resource elements associated to a synchronization signals may e.g. be resource elements associated to a block of synchronization signals, comprising e.g. PSS, SSS and PBCH (such as the SSB) and unoccupied resources within that block. The synchronization signals received with the highest power are for example associated with the beam selected by the WD and the beams neighboring the selected beam. Hence, by prohibiting the use of resource elements associated to a synchronization signal received with a power higher than the power threshold the risk for desensitization of neighboring WDs is reduced. The power threshold may herein also be referred to as a “PT-Threshold-for-SSB-PTs” or “sidelink-Threshold-for-SSB-PTs”. The power threshold may be an absolute power value or a value relative to the receive power of the synchronization signal associated with an active beam of the WD. The relative threshold may be indicated as certain dBs of the active SSB. The threshold may be signaled from the radio network node to the WDs. The indication prohibiting the WD to communicate PT on resource elements associated with synchronization signaling received with a power higher than the power threshold may however not prohibit communicating PT on resource elements located on same time resources as the synchronization signaling received with the power higher than the power threshold but on different frequencies, such as on different frequency subcarriers. In other words, the first WD may be allowed to communicate PT on resource elements located on the same time symbols as the synchronization signaling (such as the SSBs) having a receive power above the power threshold (such as the active SSB and/or SSBs of neighboring beams) but on other frequencies than allocated for the synchronization signaling (such as the SSBs). The communication of PT may be allowed on any frequencies of the BW of the radio network node, for which frequencies the WD is configured to transmit. In some exemplary methods, the WD may only be configured to transmit PT on lower frequency ranges (such as Frequency Range 1 (FR1), which covers frequencies from 450-7125 MHz). In this case the WD may be restricted to communicate PT in the frequencies of FR1. In some exemplary embodiments, the WD may be configured to transmit PT also in higher frequency ranges, such as FR2, and may thus transmit PT in FR2. The WD may also be configured to transmit PT in both FR1 and FR2.

The information indicating the resource criterion may comprise an indication that the WD, such as the first WD, is prohibited to communicate PT on resource elements, such as resource blocks, allocated to synchronization signals mapping to (or being associated with) the same Random-Access Channel (RACH) occasion as used by the WD. The radio network node may signal to the WDs that, for each WD, PT is not allowed on SSBs which map to the same RACH occasion as the active SSB of the WD. The mapping from SSBs to RACH occasions may be signaled by, e.g., a Rel.-15 parameter ssb-perRACH-Occasion, or by some other suitable messaging.

The information indicating the resource criterion may also comprise an indication of whether the WD is allowed or not allowed (prohibited) to communicate PT in resource elements associated with synchronization signaling. In other words, the information may indicate whether PT is sanctioned or not, such as PT being on/off.

The method 100 may further comprise receiving S104, from the radio network node, information indicating one or more transmission requirements for transmitting PT in the one or more second resource elements. The information indicating the one or more transmission requirements may comprise an indication of a beam width, an indication of a power level and/or an indication of a spatial direction to be used for communicating PT.

When the spatial direction is restricted, the transmission requirements may indicate that the WD is allowed to transmit in directions which will not cause a strong interference, such as interference above an interference threshold, to neighboring WDs which are listening to the same synchronization signaling as the WD performing PT. Hence, the WD may use certain resources, as indicated by the resource criterion, for PT but only for a certain direction of transmission, as indicated by the transmission requirements. The indication of a spatial direction may also forbid PT in specific directions. The specific directions may be determined on a case by case basis depending on the number of WDs served by the radio network node and their locations relative to each other.

The transmission requirements may indicate a maximum beam width that the WDs are allowed to use for PT. By reducing the beam width, the interference experienced by the neighboring WDs can be reduced since the reduced beam width covers a smaller area and thereby may reach a lower number of neighboring WDs. The radio network node may indicate to the WDs (e.g. in the transmission requirements) that only WDs capable of transmitting with a beam width smaller than a beam width threshold (which may be referred to as “PT-Max-Beamwidth-for-SSB-PTs” or “sidelink-Max-Beamwidth-for-SSB-PTs”) of predetermined degrees are allowed to engage in side link on SSBs. The beam width threshold may also me signaled from the radio network node to the WDs.

When the power level is restricted, the transmission requirements may indicate that the WD is allowed to transmit with a transmission power level below a transmission power threshold which will not cause a strong interference, such as interference above an interference threshold, to neighboring WDs which are listening to the same synchronizations signaling as the WD performing PT.

The different resource criterion and/or transmission requirements may be signaled and/or applied in addition or independently to each other.

The information, such as the information indicating the one or more resource criterion, and/or the one or more transmission requirements may be received in a control signaling message, such as a system information message. The information may be received by the WD via dedicated signaling or via broadcasted signaling from the network node.

The method 100 may further comprise determining S105, based on the received information, the one or more second resource elements to be used for PT. The determining S105, based on the received information, the one or more second resource elements for PT may comprise determining whether the one or more second resource elements satisfy the one or more resource criterion and upon a determination that the one or more second resource elements satisfy the one or more resource criterion, selecting the one or more second resource elements for PT. Depending on the resource criteria used, the WD may upon determination that the one or more resource elements satisfy the one or more resource criterion, refrain from selecting the one or more second resource elements for PT.

The determining S105 may comprise measuring S105A the power of the received one or more synchronization signals, such as the one or more SSBs. The determining S105 may further comprise determining S105B whether the power measured on the one or more synchronization signals is higher than the power threshold and upon a determination that power of the synchronization signals received is higher than the power threshold, refraining from selecting the synchronization signals with the power higher than the threshold as the one or more second resource elements. Based on the received power profile of the synchronization signals the WD may determine the resources to use for PT that have a low risk of causing interference to other WDs or radio network nodes. When e.g. the measured power of a first and a second SSB, wherein one of the first and the second SSB may be an SSB used by the WD to set up its beam, is above the power threshold, the WD may refrain from selecting these SSBs for PT. Instead, the WD may use free or occupied resources comprised in or surrounding other SSBs, which are located in the same time resources as the other SSBs. WDs depending on, i.e. listening to these other SSBs are likely distant and are thus not interfered by the PT. In other words, PTs may be allowed in occupied resources in other synchronization signaling than the active synchronization signaling of the wireless device. The radio network node may determine that this is acceptable, provided that a resource criterion is fulfilled, such as when the synchronization signal receive power being below a power threshold, and/or provided that a transmission requirement is fulfilled, such as a restriction of transmit power and/or beam-width and/or beam-direction, etc. The wireless terminal may be allowed to transmit PT in resource elements of synchronization signaling having a receive power below the power threshold. The radio network node may signal to the WD that the WD is granted access to the resources, such as time and frequency resources, of the other synchronization signaling if the resource criterion and/or the one or more transmission requirements are fulfilled.

The method 100 further comprises communicating S107 PT in one or more second resource elements located on same time resources as the synchronization signal burst. The one or more second resource elements are different from the one or more first resource elements, such as resource elements located on different frequencies (such as on different frequency subcarriers) than the first resource elements. Resource elements located on same time resources as the synchronization signal burst shall herein be interpreted as resource elements located at a time resource, such as a time symbol or a time slot, in which synchronization signaling (such as SSBs) are transmitted. The communicating S107 of PT may further comprise transmitting S107A PT in the one or more second resource elements for PT, in accordance with the one or more transmission requirements received from the radio network node.

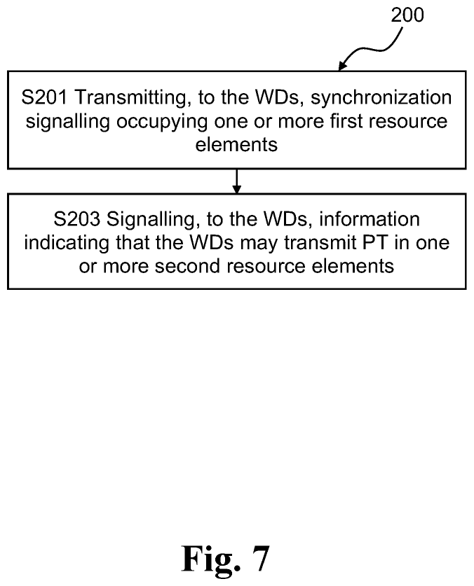

FIG. 7 shows a flow diagram of an exemplary method 200, performed in a radio network node (such as a radio network node disclosed herein, such as radio network node 400 of FIG. 1), for enabling PT from a WD in a wireless communication network. The method 200 comprises transmitting S201, to the WD, synchronization signaling occupying one or more first resource elements of a synchronization signal burst. This step S201 corresponds to the step S101 performed by the WD.

The method 200 further comprises signaling S203, to the WD, information indicating that the WD may transmit PT in one or more second resource elements located on same time resources as the synchronization signal burst. The second resource elements are different from the one or more first resource elements. In other words, information indicating that the WD may transmit PT in one or more second resource elements located on same time resources as the synchronization signal burst may be seen as information indicating that the WD is allowed to transmit PT in one or more second resource elements located on same time resources as the synchronization signal burst.

The information indicating that the WD are allowed to transmit PT may comprise one or more resource criterion for determining the one or more second resource elements. The information indicating that the WD may transmit PT may comprise the one or more transmission requirements for transmitting PT in the one or more second resource elements. For example, the one or more transmission requirements correspond to the one or more transmission requirements described in relation to S104 of FIG. 6. The radio network node may transmit the information, such as the information indicating the one or more transmission requirements and/or the information indicating one or more resource criterion, in a system information message.

The radio network node may transmit the information, such as the information indicating the one or more transmission requirements and/or the information indicating one or more resource criterion, to the WD via dedicated signaling or via broadcasted signaling.

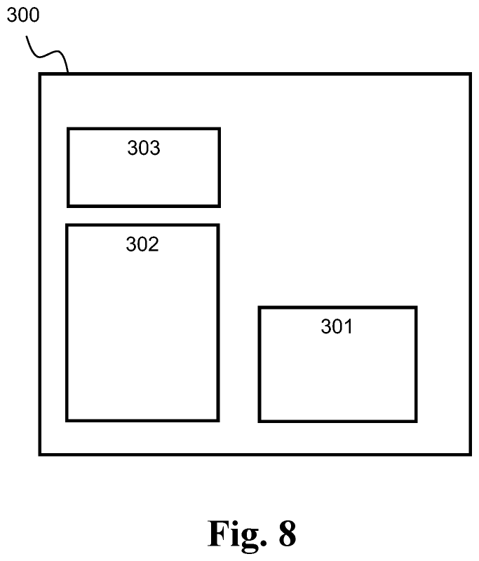

FIG. 8 shows a block diagram of an exemplary WD 300 according to the disclosure. The WD 300 comprises a memory circuitry 301, a processor circuitry 302, and a wireless interface 303. The WD 300 may be configured to perform any of the methods disclosed in FIG. 6. In other words, the network node 300 may be configured for handling PT from the WD.

The WD 300 is configured to communicate with a second WD, such as the WD 300A disclosed herein, or a radio network node (e.g. a gNB), such as the radio network node 400 disclosed herein, using a wireless communication system. When the WD 300 is communicating with the second WD 300A it may be referred to as a first WD.

The wireless interface 303 is configured for wireless communications via a wireless communication system, such as a 3GPP system, such as a 3GPP system supporting millimeter-wave communications, such as millimeter-wave communications in licensed bands, such as device-to-device millimeter-wave communications in licensed bands and/or unlicensed bands.

The WD 300 is configured to receive, e.g. via the wireless interface 403, from the radio network node, synchronization signaling occupying one or more first resource elements of a synchronization signal burst transmitted by a radio network node. The WD 300 is further configured to communicate PT in one or more second resource elements located on same time resources as the synchronization signal burst, wherein the one or more second resource elements are different from the one or more first resource elements.

The processor circuitry 302 is optionally configured to perform any of the operations disclosed in FIG. 6 (such as any one or more of S103, S104, S105, S105A, S105B, S107A). The operations of the WD 300 may be embodied in the form of executable logic routines (e.g., lines of code, software programs, etc.) that are stored on a non-transitory computer readable medium (e.g., the memory circuitry 301) and are executed by the processor circuitry 302).

Furthermore, the operations of the WD 300 may be considered a method that the network node 300 is configured to carry out. Also, while the described functions and operations may be implemented in software, such functionality may as well be carried out via dedicated hardware or firmware, or some combination of hardware, firmware and/or software.

The memory circuitry 301 may be one or more of a buffer, a flash memory, a hard drive, a removable media, a volatile memory, a non-volatile memory, a random access memory (RAM), or other suitable device. In a typical arrangement, the memory circuitry 301 may include a non-volatile memory for long term data storage and a volatile memory that functions as system memory for the processor circuitry 302. The memory circuitry 301 may exchange data with the processor circuitry 302 over a data bus. Control lines and an address bus between the memory circuitry 301 and the processor circuitry 302 also may be present (not shown in FIG. 8). The memory circuitry 301 is considered a non-transitory computer readable medium.

The memory circuitry 301 may be configured to store information, such as resource criteria, transmission requirements, in a part of the memory.

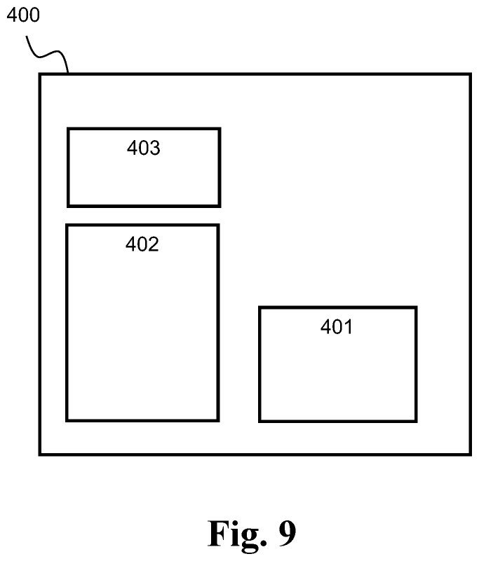

FIG. 9 shows a block diagram of an exemplary radio network node 400, such as a gNB, according to the disclosure. The radio network node 400 comprises a memory circuitry 401, a processor circuitry 402, and a wireless interface 402. The radio network node 400 may be configured to perform any of the methods disclosed in FIG. 7. In other words, the radio network node 400 may be configured for enabling PT from a WD in a wireless communication network.

The radio network node 400 is configured to communicate with a WD, such as the WD 300 disclosed herein, using a wireless communication system.

The wireless interface 403 is configured for wireless communications via a wireless communication system, such as a 3GPP system, such as a 3GPP system supporting millimeter-wave communications, such as millimeter-wave communications in licensed bands, such as device-to-device millimeter-wave communications in licensed bands and/or unlicensed bands.

The network node 400 is configured to transmit, e.g. via the wireless interface 403, to the WD, synchronization signaling occupying one or more first resource elements of a synchronization signal burst. The network node 400 is further configured to signal, e.g. via the wireless interface 403, to the WD, information indicating that the WD may transmit PT in one or more second resource elements located on same time resources as the synchronization signal burst, wherein the second resource elements are different from the one or more first resource elements.

The processor circuitry 402 is optionally configured to perform any of the operations disclosed herein for the radio network node, such as in FIG. 7. The operations of the network node 400 may be embodied in the form of executable logic routines (e.g., lines of code, software programs, etc.) that are stored on a non-transitory computer readable medium (e.g., the memory circuitry 401) and are executed by the processor circuitry 402).

Furthermore, the operations of the network node 400 may be considered a method that the network node 400 is configured to carry out. Also, while the described functions and operations may be implemented in software, such functionality may as well be carried out via dedicated hardware or firmware, or some combination of hardware, firmware and/or software.

The memory circuitry 401 may be one or more of a buffer, a flash memory, a hard drive, a removable media, a volatile memory, a non-volatile memory, a random access memory (RAM), or other suitable device. In a typical arrangement, the memory circuitry 401 may include a non-volatile memory for long term data storage and a volatile memory that functions as system memory for the processor circuitry 402. The memory circuitry 401 may exchange data with the processor circuitry 402 over a data bus. Control lines and an address bus between the memory circuitry 401 and the processor circuitry 402 also may be present (not shown in FIG. 9). The memory circuitry 401 is considered a non-transitory computer readable medium.

The memory circuitry 401 may be configured to store information, such as resource criteria, transmission requirements, in a part of the memory.

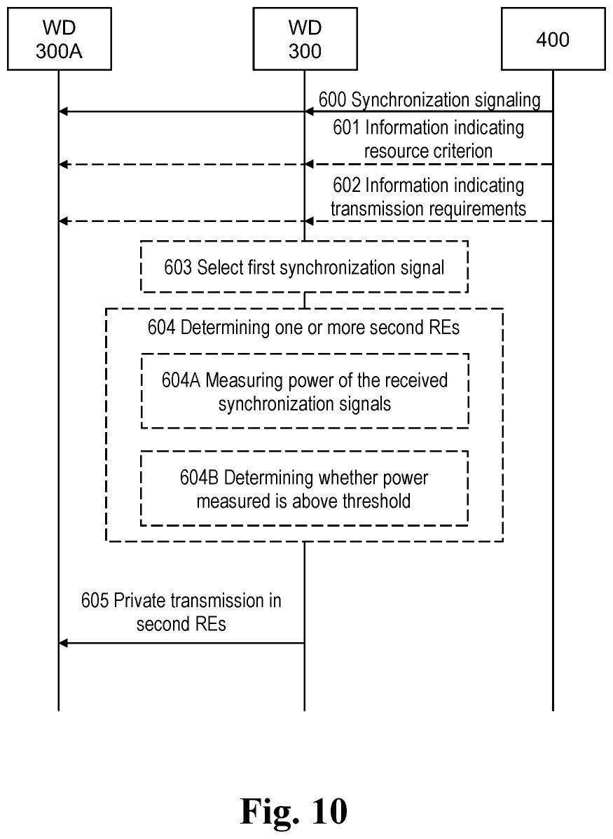

FIG. 10 is a signaling diagram illustrating an exemplary message exchange between an exemplary first WD 300, such as a UE, an exemplary radio network node 400, such as a gNB, and an exemplary second WD 300A, during an exemplary procedure for handling PT.

The radio network node 400 periodically transmits 600 synchronization signaling sequences (such as SSBs) in a number of directions using a set of transmit beams during an SSB burst. The synchronization signaling may be transmitted using a broadcasted message. This step 600 corresponds to step 1 of FIG. 5, step S101 of FIG. 6 and step S201 of FIG. 7.

The radio network node 400 may further transmit 601 information indicating one or more resource criteria to the first and the second WD 300, 300A. The information indicating the one or more resource criterion may be transmitted to the WDs using a broadcasted message or via direct signaling. This step 601 corresponds to step S103 of FIG. 6 and is similar to step S203 of FIG. 7.

The radio network node 400 may further transmit 601 information indicating one or more transmission requirements to the first and the second WD 300, 300A. The information indicating the one or more transmission requirements may be transmitted to the WDs using a broadcasted message or via direct signaling. This step 602 corresponds to step S104 of FIG. 6 and is similar to step S203 of FIG. 7.

The WDs 300 may measure the power of each set of synchronization signaling in the sequence and may select to receive a first of the transmitted synchronization signals (such as a first SSB) and corresponding PBCHs. Based on the measured signal strength of the broadcasted synchronization signaling the WDs may select e.g. the respective strongest synchronization signaling as the first synchronization signaling for communication with the radio network node, together with a suitable receive spatial filter (receive beam).

Based on the received synchronization signaling and/or the information indicating one or more resource criterion, the WDs 300 may determine 604 one or more second resource elements to be used for PT from the WD. This step 602 corresponds to step S105 of FIG. 6.

The WD may determine the one or more second resource elements, by measuring 604A a power of the received synchronization signaling and determine 604B whether the power measured is above a threshold. When the measured power is below the threshold, the WD 300 can select the resource elements associated with this synchronization signaling (such as empty resources within an SSB or empty resources on same time symbols as occupied by the synchronization signaling but on other frequency resources) for PT. When the measured power is equal to or above the threshold, the WD 300 refrains from using the resource elements of this synchronization signaling (such as resource elements allocated for SSBs) for PT. The step 604A corresponds to step 105A of FIG. 6. The step 604B corresponds to step 105B of FIG. 6.

The WD 300 further performs PT 605 to the WD 300A in the determined one or more second resource elements. The WD 300 may transmit the PT in accordance with the received information indicating transmission requirements. This step 605 corresponds to step S107 of FIG. 6.

Embodiments of methods and products (radio network node and wireless device) according to the disclosure are set out in the following items:

Item 1. A method performed by a Wireless Device, WD, for handling one or more private transmissions, PT, from the WD in a wireless communication network, the method comprising:
receiving (S101) synchronization signaling, occupying one or more first resource elements of a synchronization signal burst transmitted by a radio network node, and
communicating (S107) PT in one or more second resource elements located on same time resources as the synchronization signal burst, wherein the one or more second resource elements are different from the one or more first resource elements.

Item 2. The method according to item 1, wherein the method comprises:
receiving (S103), from the radio network node, information indicating one or more resource criterion for determining the one or more second resource elements, and
determining (S105), based on the received information, the one or more second resource elements to be used for PT.

Item 3. The method according to item 1 or 2, wherein the method comprises:
receiving (S104), from the radio network node, information indicating one or more transmission requirements for transmitting PT in the one or more second resource elements, and
wherein the communicating (S107) comprises transmitting (S107A) PT in the one or more second resource elements for PT, in accordance with the one or more transmission requirements.

Item 4. The method according any one of the items 2 to 3 when dependent on item 2, wherein the information indicating the resource criterion comprises an indication of resource elements that are allowed and/or resource elements prohibited to be used for communicating PT.

Item 5. The method according to any one of the items 2 to 4 when dependent on item 2, wherein the information indicating the resource criterion comprises an indication that the first WD is prohibited to communicate PT on resource elements associated to a synchronization signal received with a power higher than a power threshold.

Item 6. The method according to item 5, wherein the power threshold is an absolute power value or a value relative to the receive power of a synchronization signal associated with an active beam of the WD.

Item 7. The method according to item 5 or 6, wherein the determining (S105) comprises
measuring (S105A) the power of the received one or more synchronization signals, and
determining (S105B) whether the power measured on the one or more synchronization signals is higher than the power threshold and upon a determination that power of the synchronization signals received is higher than the power threshold, refraining from selecting the synchronization signals with the power higher than the threshold as the one or more second resource elements.

Item 8. The method according to any of the items 2 to 7 when dependent on claim 2, wherein the information indicating the resource criterion comprises an indication that the first WD is prohibited to communicate PT on resource elements allocated to synchronization signals mapping to the same Random-Access Channel, RACH, occasion as used by the WD.

Item 9. The method according to any one of the items 3 to 8 when dependent on item 3, wherein the information indicating the one or more transmission requirements comprises an indication of a beam width to be used for communicating PT.

Item 10. The method according to any one of the items 3 to 9 when dependent on item 3, wherein the information indicating the one or more transmission requirements comprises an indication of a power level to be used for communicating PT.

Item 11. The method according to any one of the items 3 to 10 when dependent on item 3, wherein the information indicating the one or more transmission requirements comprises an indication of a spatial direction to be used for communicating PT.

Item 12. The method according to any one of the items 2 to 11, wherein the information, such as the information indicating the one or more transmission requirements and/or the information indicating one or more resource criterion, is received in a system information message.

Item 13. The method according to any one of the items 2 to 12, wherein the information is received by the WD via dedicated signaling or via broadcasted signaling from the network node.

Item 14. The method according to any of the previous items, wherein the resource elements are resources in a time domain and in a frequency domain.

Item 15. A method, performed in a radio network node, for enabling private transmissions, PT, from a Wireless Device, WD, in a wireless communication network, the method comprising:
transmitting (S201), to the WD, synchronization signaling occupying one or more first resource elements of a synchronization signal burst, and
signaling (S203), to the WD, information indicating that the WD may transmit PT in one or more second resource elements located on same time resources as the synchronization signal burst, wherein the second resource elements are different from the one or more first resource elements.

Item 16. The method according to item 15, wherein the information indicating that the WD are allowed to transmit PT comprises one or more resource criterion for determining the one or more second resource elements.

Item 17. The method according to item 15 or 16, wherein the information indicating that the WD may transmit PT comprises one or more transmission requirements for transmitting PT in the one or more second resource elements.

Item 18. The method according to any one of the items 15 to 17, wherein the information, such as the information indicating the one or more transmission requirements and/or the information indicating one or more resource criterion, is transmitted in a system information message.

Item 19. The method according to any one of the items 15 to 18, wherein the information is transmitted to the WD via dedicated signaling or via broadcasted signaling.

Item 20. A wireless device comprising a memory circuitry, a processor circuitry, and a wireless interface, wherein the wireless device is configured to perform any of the methods according to any of items 1-14.

Item 21. A radio network node comprising a memory circuitry, a processor circuitry, and a wireless interface, wherein the radio network node is configured to perform any of the methods according to any of items 15-19.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labeling purposes only and are not intended to denote any specific spatial or temporal ordering. Furthermore, the labeling of a first element does not imply the presence of a second element and vice versa.

It may be appreciated that FIGS. 1-10 comprises some circuitries or operations which are illustrated with a solid line and some circuitries or operations which are illustrated with a dashed line. The circuitries or operations which are comprised in a solid line are circuitries or operations which are comprised in the broadest example embodiment. The circuitries or operations which are comprised in a dashed line are example embodiments which may be comprised in, or a part of, or are further circuitries or operations which may be taken in addition to the circuitries or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

The various exemplary methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly to be regarded in an illustrative rather than restrictive sense. The claimed disclosure is intended to cover all alternatives, modifications, and equivalents.

1. A method performed by a Wireless Device (WD) for handling private transmissions (PT) from the WD in a wireless communication network, the method comprising:
receiving synchronization signaling, occupying one or more first resource elements of a synchronization signal burst transmitted by a radio network node, and
communicating PT in one or more second resource elements located on same time resources as the synchronization signal burst, wherein the one or more second resource elements are different from the one or more first resource elements.

2. The method according to claim 1, wherein the method comprises:
receiving, from the radio network node, information indicating one or more resource criterion for determining the one or more second resource elements, and
determining, based on the received information, the one or more second resource elements to be used for PT.

3. The method according to claim 1, wherein the method comprises:
receiving, from the radio network node, information indicating one or more transmission requirements for transmitting PT in the one or more second resource elements, and
wherein the communicating comprises transmitting PT in the one or more second resource elements for PT, in accordance with the one or more transmission requirements.

4. The method according to claim 2, wherein the information indicating the resource criterion comprises an indication of resource elements that are allowed and/or resource elements prohibited to be used for communicating PT.

5. The method according to claim 2, wherein the information indicating the resource criterion comprises an indication that the WD is prohibited to communicate PT on resource elements associated to a synchronization signal received with a power higher than a power threshold.

6. The method according to claim 5, wherein the power threshold is an absolute power value or a value relative to the receive power of a synchronization signal associated with an active beam of the WD.

7. The method according to claim 5, wherein the determining comprises
measuring the power of the received one or more synchronization signals, and
determining whether the power measured on the one or more synchronization signals is higher than the power threshold and upon a determination that power of the synchronization signals received is higher than the power threshold, refraining from selecting the synchronization signals with the power higher than the threshold as the one or more second resource elements.

8. The method according to claim 2, wherein the information indicating the resource criterion comprises an indication that the WD is prohibited to communicate PT on resource elements allocated to synchronization signals mapping to the same Random-Access Channel, RACH, occasion as used by the WD.

9. The method according to claim 3, wherein the information indicating the one or more transmission requirements comprises an indication of a beam width to be used for communicating PT.

10. The method according to claim 3, wherein the information indicating the one or more transmission requirements comprises an indication of a power level to be used for communicating PT.

11. The method according to claim 3, wherein the information indicating the one or more transmission requirements comprises an indication of a spatial direction to be used for communicating PT.

12. The method according to claim 2, wherein the information is received in a system information message.

13. The method according to claim 2, wherein the information is received by the WD via dedicated signaling or via broadcasted signaling from the network node.

14. The method according to claim 1, wherein the resource elements are resources in a time domain and in a frequency domain.

15. A method, performed in a radio network node, for enabling private transmissions (PT) from a Wireless Device in a wireless communication network, the method comprising:
transmitting, to the WD, synchronization signaling occupying one or more first resource elements of a synchronization signal burst, and
signaling, to the WD, information indicating that the WD may transmit PT in one or more second resource elements located on same time resources as the synchronization signal burst, wherein the second resource elements are different from the one or more first resource elements.

16. The method according to claim 15, wherein the information indicating that the WD are allowed to transmit PT comprises one or more resource criterion for determining the one or more second resource elements.

17. The method according to claim 15, wherein the information indicating that the WD may transmit PT comprises one or more transmission requirements for transmitting PT in the one or more second resource elements.

18. The method according to claim 15, wherein the information is transmitted in a system information message, or wherein the information is transmitted to the WD via dedicated signaling or via broadcasted signaling.

19. (canceled)

20. A wireless device comprising a memory circuitry, a processor circuitry, and a wireless interface, wherein the wireless device is configured to perform the method of claim 1.

21. A radio network node comprising a memory circuitry, a processor circuitry, and a wireless interface, wherein the radio network node is configured to perform the method of claim 15.
